(19) United States
(12) Patent Application Publication
(10) Pub. No.: US 2006/0093234 A1
(43) Pub. Date: May 4, 2006

(54) Reduction of blur in multi-channel images

(76) Inventor: D. Amnon Silverstein, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/982,459

(22) Filed: Nov. 4, 2004

(51) Int. Cl. G06K 9/40

(52) U.S. Cl. 382/255

(57) ABSTRACT

A color digital image is processed to reduce blur. First and second color channels of a high frequency feature (e.g., an edge) in the image are compared to derive information that is missing from the second channel due to the blur. The information is used to adjust the feature in the second channel so that sharpeness of the feature is similar in both the first and second channels. As a first example, the processing may be used to correct chromatic aberration in an image captured by a digital camera. As a second example, the processing may be used to reduce blur in images created during film restoration.

### BACKGROUND

Imaging systems typically capture images with separable wavelength channels (e.g., red, green and blue channels). For example, a typical digital camera includes a photosensor array and refractive optics for focusing images on the photosensor array. Each photosensor of the array is sensitive to one of red, green and blue light. During image capture, an image is focused on the photosensor array, and the red-sensitive photosensors capture a red channel of the image, the blue-sensitive photosensors capture a blue channel of the image, and the green-sensitive photosensors capture a green channel of the image. The photosensor array outputs a digital image as red, green and blue channels.

Refractive material for camera optics has different indices of refraction for different wavelengths of light. Consequently, lens power varies as a function of the color of light. For example, distant objects in an image might be sharpest in the red channel, near objects might be sharpest in the blue channel, and objects at intermediate distances might be sharpest in the green channel. However, this chromatic aberration causes near objects to appear blurred in the red and green channels, far objects to appear blurred in the blue and green channels, and intermediate objects to appear blurred in the red and blue channels. The amount of blurring is proportional to lens aperture and the degree of defocus.

Blurring due to chromatic aberration is prominent in images taken by cameras with inexpensive optics. It is especially prominent in cameras using single plastic lenses.

Blurring due to chromatic aberration can be reduced through the use of multiple lenses, and lenses made of different materials. However, this solution increases the cost of the optics. Moreover, the solution does not correct chromatic aberrations in digital images that have already been captured by other devices.

### SUMMARY

According to one aspect of the present invention, reduction of blur in a multi-channel image includes comparing first and second color channels of a high frequency feature in the image to derive information that is missing from the second channel due to the blur; and using the information to adjust the feature in the second channel so that sharpeness of the feature is similar in both the first and second channels.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is an illustration of a general method of processing a color digital image according to an embodiment of the present invention.

FIG. 2 is an illustration of a method of processing a color digital image according to an embodiment of the present invention.

FIGS. 3a-3f illustrate the reduction of blur in a high frequency feature according to the method of FIG. 2.

FIG. 4 is an illustration of a method of processing a color digital image according to an embodiment of the present invention.

FIGS. 5a-5d illustrate the reduction of blur in a high frequency feature according to the method of FIG. 4.

FIG. 6 is an illustration of a method of processing a color digital image according to an embodiment of the present invention.

FIG. 7 is an illustration of a system for processing a color digital image according to an embodiment of the present invention.

FIG. 8 is an illustration of an image capture device according to an embodiment of the present invention.

FIG. 9 is an illustration of a system for restoring film according to an embodiment of the present invention.

### DETAILED DESCRIPTION

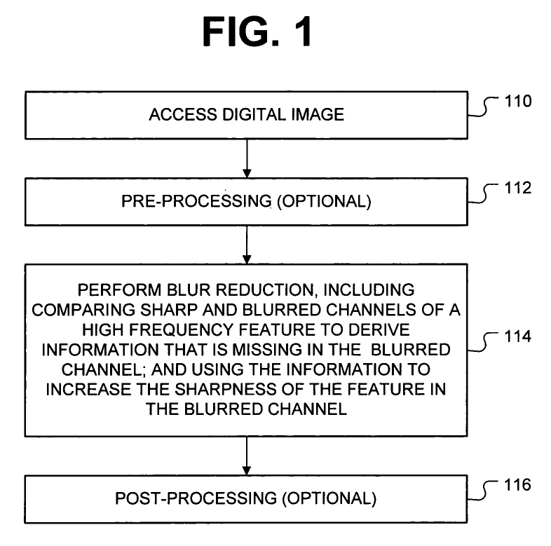

Reference is made to FIG. 1, which illustrates a general method of processing a multi-channel digital image according to the present invention. The image is represented as an array of pixels. In the spatial domain, each pixel is represented by an n-bit word. In a typical 24-bit word representing RGB color space, for instance, eight bits represent a red channel, eight bits represent a green channel, and eight bits represent a blue channel.

Preferably, the colors do not overlap spectrally. If there is overlap, the blur from one channel could affect the overlapping channels as well. Preferably, the color channels are not color-corrected prior to the processing described below. Color correction would transfer color information from one channel to another, and, therefore, would move the blur from one channel to an overlapping channel.

At block 110, the digital image is accessed. The digital image may be accessed from an image capture device (e.g., a scanner, a digital camera), it may be retrieved from data storage (e.g., a hard drive, an optical disc), etc.

At block 112, pre-processing may be performed. The pre-processing may include performing color channel registration to ensure that the color channels of the digital image have direct spatial correspondence. Color channel registration ensures that high frequency features in one color channel are in the same spatial location in the other color channels. Some image capture devices produce images with full color at each pixel. For example, a capture device has a photosensor array including a first row of photodiodes that sample red information, a second row of diodes that sample green information and a third row of diodes that sample blue information. The three rows of photodiodes are physically separated. Electronics or software of scanner can shift the red and blue samples into alignment (registration) with the green samples. The shifted samples have direct spatial correspondence. For devices that produce channels having direct spatial correspondence, color registration is not performed during pre-processing. For images that do not have direct spatial correspondence, registration is performed during pre-processing.

Other capture devices provide less than full color at each pixel. Certain digital cameras produce digital images having only one of red, green and blue samples at each pixel. These mosaic images do not have direct spatial correspondence. During pre-processing, demosaicing is performed to fill in the missing color information at each pixel. Consider an image that was sampled with a color filter array, such as a Bayer array. Each sample corresponds to a different image region. In addition, this mosaic image has twice as many green samples as either red or blue. Each color channel is treated as a separate image. Demosaicing may be performed to fill in the missing information in each image. The blue and green images are then up-sampled to have the same resolution as the green image. However, the green image is sharper than the up-sampled blue and red images. Next, the images are brought into registration. For example, an exhaustive search could be performed to find an affine transformation that minimizes the squared difference between the sharp (green) channel and the up-sampled blurred (blue and red) images.

The pre-processing may also include pixel noise reduction. If pixel noise is not removed, the pixel noise might be copied from one channel to another in the later stages of processing. The pixel noise may be removed, reduced or at least prevented from being overly amplified by a median filter. The median filter removes on point-like noise from the image, without affecting the sharpness of edges in the image. For a description of a median filter, see for example a paper by Raymond H. Chan et al. entitled “Salt-and-Pepper Noise Removal by Median-type Noise Detectors and Detail-preserving Regularization” (Jul. 30, 2004).

If some of the later stages of processing (e.g., linear spatial frequency decomposition) use linear filtering, it would be useful to adjust the digital image levels so they are linear relative to the amount of light captured at each pixel. The digital image levels can be adjusted during pre-processing.

In block 114, blur in the pre-processed image is reduced. The blur reduction includes comparing first and second color channels of a high frequency feature in the image to derive information that is missing from the second channel due to the blur; and using the information to adjust the feature in the second channel so that sharpeness of the feature is similar in both the first and second channels. The blur reduction can be extended to a third channel that is not as sharp as the first channel. The first and third channels of the high frequency feature are compared to derive additional information that is missing from the third channel due to the blur. The additional information is used to adjust the feature in the third channel so that sharpeness of the feature is similar in the first, second and third channels.

High frequency features refer to features having abrupt transitions in intensity. Examples of high frequency features include, without limitation, edges and texture. The high frequency features do not include point-like noise, which was removed from the image during pre-processing.

As a first example, a digital image has red, green and blue channels. The red channel is blurred, while the blue and green channels are equally sharp. Blur reduction at block 114 may include computing differences between high frequency features in the red and green channels; and combining these difference with the features in the red channel so that sharpness of the features in the red channel have similar sharpness to the features in the green channel.

As a second example, a digital image has red, green and blue channels, and the green channel is sharpest for all features. For a given feature in the image, a first difference is taken between the given feature in the green channel and the given feature in the red channel, and a second difference is taken between the given feature in the blue and green channels. The first difference is combined with the feature in the red channel, and the second difference is combined with the feature in the blue channel so that sharpness of the feature is similar in all three color channels. Blur of the feature is reduced, without significantly affecting color gain in the adjusted channels.

In block 116, post-processing may be performed. Post-processing may include conventional sharpening such as unsharp masking or deconvolution. The sharpening can be useful if high frequency information has been lost in all of the color channels. The post-processing may further include, without limitation, color correction, contrast enhancement, and compression.

The post-processing may also include outputting the image. Examples of outputting the image include, but are not limited to, printing out the image, transmitting the digital image, storing the digital image (e.g., on a disc for redistribution), and displaying the digital image on a monitor.

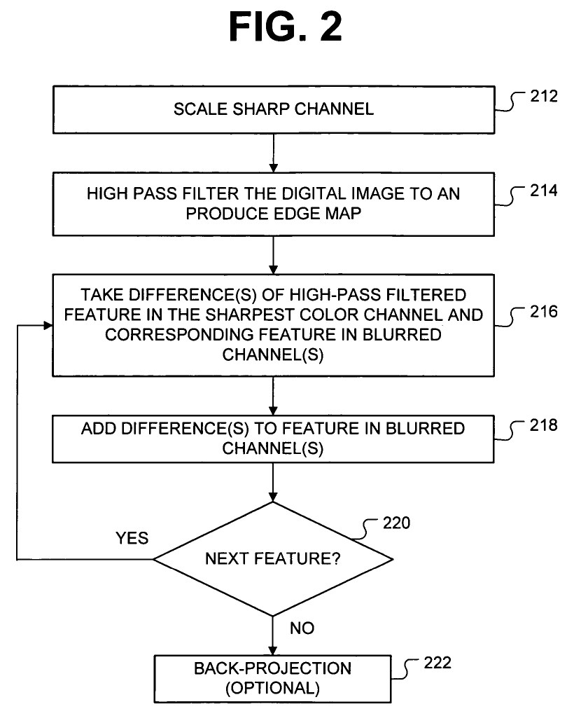

Different embodiments of methods of performing blur reduction (at block 114) will now be described. Three embodiments are illustrated in FIGS. 2, 4 and 6. As will become apparent, however, the blur reduction according to the present invention is not limited to the embodiments illustrated in FIGS. 2, 4 and 6.

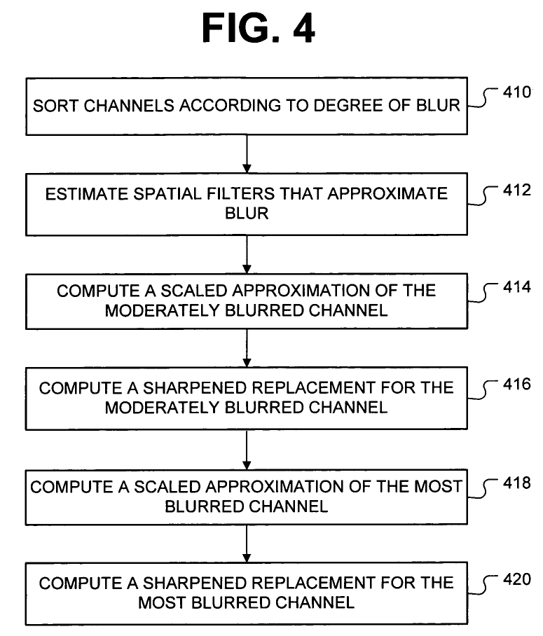

FIGS. 2 and 4 illustrate global approaches toward blur reduction. In the global approaches, the color channel having the sharpest edges is already known. This assumption is application-specific. The assumption could be based on prior measurement of high frequency features in the different color channels. The assumption could be determined from image statistics. For example, the color channel that has the most high frequency energy can be used as the sharp channel.

The assumption could be based on knowledge of the system that produced the digital image. For example, the blur reduction is performed on an image having up-sampled red and blue channels (e.g., the image prior to pre-processing was a mosaic image with a Bayer pattern). The green channel is assumed to be sharper than the red and blue channels.

The assumption could be based on knowledge of the image source. Consider an example in which the blur reduction is used to restore Kodak® film. The color channels of the Kodak® film are arranged in layers, and light passes through the green layer before passing through the blue and red layers. Therefore, the green channel will always have the sharpest edges. In contrast, the red channel of early Technicolor® film is always less sharp than the blue and green channels.

Reference is now made to FIG. 2, which illustrates the first embodiment of blur reduction. At block 212, the sharp channel is scaled to have the approximate intensity levels of the blurred channel(s). In most natural scenes, the color channels are highly correlated, and this correlation can be used to estimate information that has been lost due to distortion such as blur. An edge that occurs in one channel tends to also occur in the other channels. However, the magnitude of the edge may vary from one channel to another. The two sides of the edge may have different colors, so the edge may be stronger in some channels than in others. The scaling is performed to equalize the edge strength across the color channels.

The scaling can be global or spatially varying. The scaling can be obtained from a linear regression. For example, to scale the blue channel to have similar levels to the red channel, the linear regression parameters a and b can be found such that
Red≅a+b×Blue
where the approximation is in the minimum squared error sense. Scaling methods other than linear regression may be used.

In block 214, the digital image is high-pass filtered. The high-pass filtering produces an edge map. The edge map identifies edges and other high frequency features in the digital image. The high-pass filtering also sharpens the high frequency features in the digital image. As a first example, a Laplacian filter can be used to perform the high-pass filtering. As a second example, a filtering kernel can be estimated. The filtering kernel would reduce the spatial frequency energy of the sharp channel to be similar to that of the blurred channel. The filtering kernel can be estimated by hand, with trial and error, especially if the blur is approximately Gaussian. Gaussian blur only has one relevant parameter, and this parameter can be found with trial and error, or it can be found with regression techniques if the image noise is not too strong or if the noise has been filtered out. The kernel can be applied to the sharp channel as a convolution kernel to produce a low-pass version of the sharp channel. This low-pass version is subtracted from the sharp channel to produce a high-pass version of the sharp channel.

Each high frequency feature in the digital image is processed according to blocks 216-220. At block 216, a difference is taken between the high-pass filtered feature in the identified color channel and each of the other color channels. If the image has red, green and blue channels, and if the green channel has the sharpest feature, then a first difference is taken between the high-pass filtered feature in the red and green channels, and a second difference is taken between the high-pass filtered feature in the blue and green channels. The differences may be computed by subtracting the green channel from each of the blue and red channels.

At block 218, sharpness of the feature in other (non-selected) color channels is adjusted according to the differences. If the green channel has the sharpest feature, the first difference is combined with the feature in the red channel of the original image, and the second difference is combined with the feature in the blue channel of the original image. A difference may be combined with a feature by adding the intensity values of the difference to the intensity values of the feature. In the alternative, the difference may be smoothly combined with the feature. A difference may be smoothly combined with its corresponding feature by convolution with a Gaussian kernel.

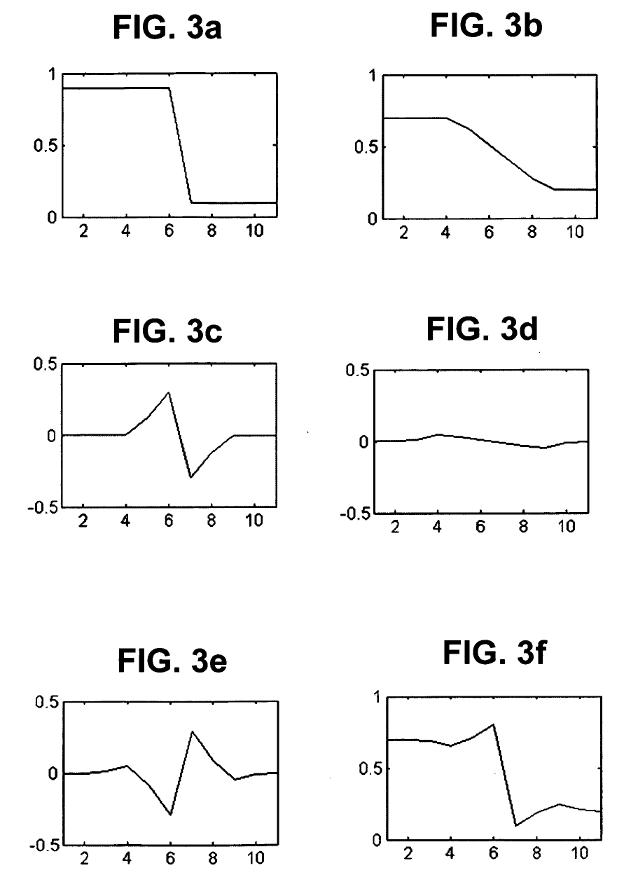

Consider the example of an edge, the processing of which is illustrated in FIGS. 3a-3f. In these FIGS. 3a-3f, the abscissa indicates pixel position, and the ordinate indicates normalized intensity. The edge of the original image is sharper in the green channel (FIG. 3a) than in the red channel (FIG. 3b). FIGS. 3c and 3d illustrate the edge of FIGS. 3a and 3b after high-pass filtering. FIG. 3e illustrates a difference between the high-pass filtered edge in the green and red channels. FIG. 3f illustrates the edge of FIG. 3b (the edge in the red channel of the original image) after combined with the difference.

Reference is once again made to FIG. 2. At block 222, the sharpness of the high frequency features may be further adjusted. An iterative back-projection method may be used to adjust the sharpness of the features. For each iteration, the image with the modified features is high pass filtered, and steps 216-220 are repeated. The back-projection may be performed a fixed number of times (e.g., four) or until a convergence criteria is met. To help converge, a weighted average may used for the last and earlier iterations. The last iteration could be assigned the highest weight. If the last iteration is assigned too high a weight, the results might not converge. If the last iteration is assigned too low a weight, many iterations might be needed.

In some embodiments, though, the image quality might be sufficient without the further edge adjustment. In such embodiments, the back-projection or other edge adjustment can be eliminated.

Reference is now made to FIG. 4, which illustrates the second embodiment of reducing blur in a digital image. At block 410, the channels are sorted by their degree of blur. Let A represent the least blurred channel, B represent the moderately blurred channel, and C represent the most blurred channel. The degree of blur can be measured by computing the image's signal power above a chosen frequency cut off. Alternatively, the degree of blur can be manually chosen. Other means can be used as well.

At block 412, spatial filters L_{b} and L_{c} that approximate blur are estimated for channels B and C, respectively. The spatial filter L_{b} can be applied to the least blurred channel A so that L_{b}(A) will have approximately the same blur as the moderately blurred channel B. The spatial filter L_{c} can be applied to the least blurred channel A so that L_{c}(A) will have approximately the same blur as the most blurred channel C.

At block 414, a scaled approximation of the moderately blurred channel B is computed. The least blurred channel A may be scaled to compute a first approximation Bˆ of the moderately blurred channel B. For example, a linear regression may be used to compute two parameters a and b where Bˆ=A×a+b≅B.

At block 416, a sharpened replacement for the moderately blurred channel is computed. The sharpened replacement B′ may be computed as B′=N_{b}(B)+(Bˆ−L_{b}(Bˆ)), where N_{b} is a low pass filter that reduces noise in the moderately blurred channel B. The filters N_{b} and L_{b} may be the same.

A sharpened replacement for the most blurred channel C is then computed from the least blurred channel A and the sharpened replacement B′. At block 418, a scaled approximation of the most blurred channel C is computed. For example, a first approximation Cˆ of the most blurred channel C may be found by linear regression with parameters c, d, e. These parameters scale the least blurred channel A and the sharpened replacement B′ to form the approximation Cˆ. The first approximation may be computed as Cˆ=B′×c+A×d+e≅C.

At block 420, the sharpened replacement C′ for the most blurred channel C may be computed as C′=N_{c}(C)+(Cˆ−L_{c}(Cˆ)), where N_{c} is a low pass filter that reduces noise in the most blurred channel C. The filters N_{c} and L_{c} may be the same

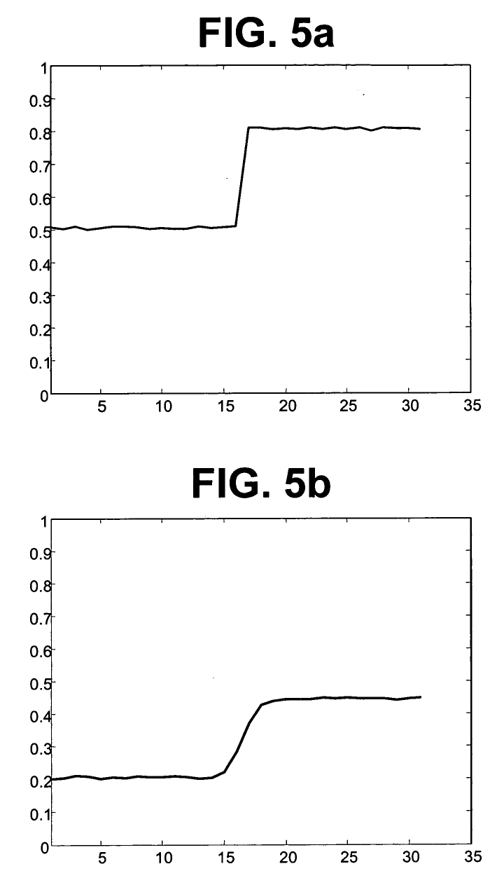

Consider the example of an edge in a color image. FIGS. 5a-5d illustrate the processing of the edge according to the method of FIG. 4. In FIGS. 5a-5d, the abscissa indicates pixel position, and the ordinate indicates normalized intensity. FIG. 5a illustrates the edge in the least blurred color channel of an image. FIG. 5b illustrates the edge in one of the other (more blurred) color channels. FIG. 5c illustrates the scaled approximation of the edge in the other color channel. FIG. 5d illustrates the sharpened replacement of the edge in the other color channel.

FIGS. 2 and 4 illustrate global approaches toward blur reduction. In some instances, however, the sharpest color channel will vary from pixel to pixel. For example, in a digital image captured by a digital camera, some objects might have better focus in the blue channel, other objects might have better focus in the red channel, and other objects might have better focus in the green channel. If the sharpest color channel varies from pixel to pixel, the blur reduction may be performed one pixel at a time.

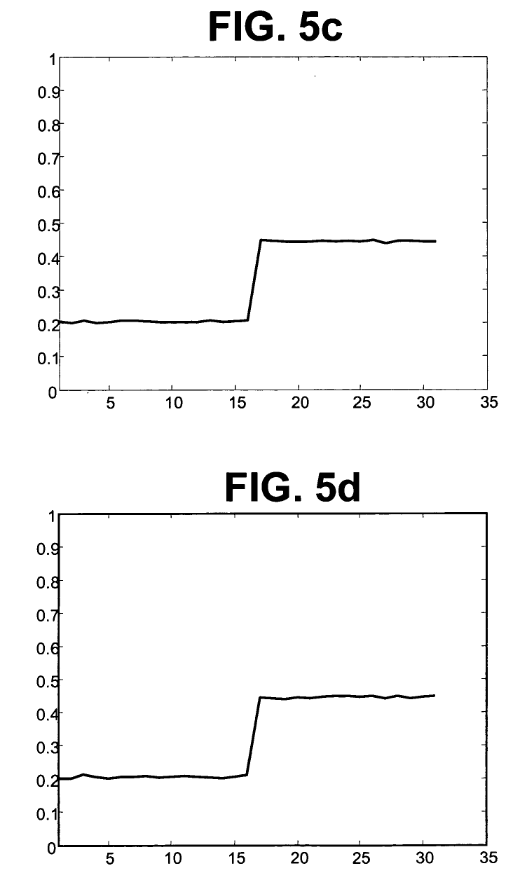

Reference is now made to FIG. 6, which shows a method of performing blur reduction one pixel at a time. The pixel noise reduction (performed at block 112 in FIG. 1) can be moved from pre-processing to blur reduction and performed one pixel at a time. To do spatial frequency processing, at least some neighborhood information is used for each pixel being processed. The image could be processed in overlapping pixel blocks in no particular order.

At block 610, noise is removed from the pixel. A median filter could be implemented on a pixel-by-pixel basis as follows. For each color channel of the pixel, an index of the strongest is created, and each index is replaced with the median value for its 5×5 neighborhood.

At block 612, the pixel is high-pass filtered. For example, a Laplacian may be computed by convolving a 3×3 kernel with a 5×5 neighborhood of the pixel being processed. Other similar kernels, such as the Sobel kernel, may be used instead. See K. L. Boyer and S. Sarkar, “Assessing the State of the Art in Edge Detection: 1992”, SPIE Conference on Applications of Artificial Intelligence X: Machine Vision and Robotics, Orlando, Fla., April 1992, pp. 353-362.

At block 614, the sharpest channel is identified. This can be done on a pixel-by-pixel basis by first applying an edge detecting filter to each channel, such as the Laplacian filter, and then by finding the maximum of the square of each of these filtered image channels.

At block 616, a pixel difference is computed for each blurred channel. The pixel difference is the difference between the high pass filtered pixel and the pixel in the blurred channel. Each difference is a single pixel value.

At block 618, the pixel differences are added to the corresponding pixel values in the original image.

At block 620, back projection is performed. The back projection uses at least one neighborhood of the pixel being processed. The goal of the back projection is to match the candidate image to the original image if it is blurred. If the image has been sharpened, an estimate of the blur is available. When that blur is applied to the sharpened image, original blurred image should be produced.

The processing at blocks 610-622 is performed on each additional pixel. The method of FIG. 6 may be performed on each pixel of the digital image, regardless of whether the pixels contain edges or other high frequency features. In the alternative, the method of FIG. 6 could be selectively applied to any region of the image. For example, just the areas with sufficiently strong edges could be processed.

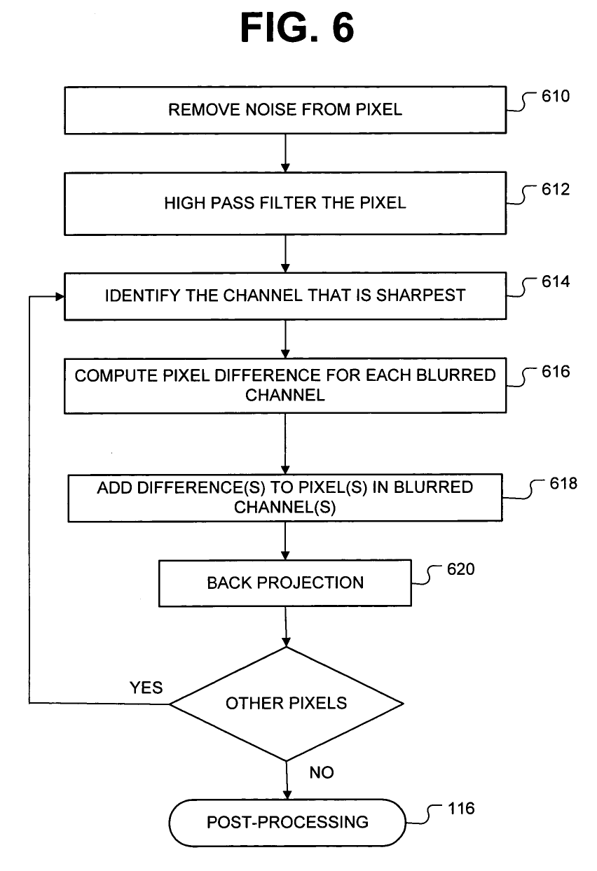

Reference is now made to FIG. 7, which illustrates a machine 710 including a processor 712 and memory 714 encoded with data 716. When executed, the data 716 causes the processor 712 to reduce chromatic aberration in a digital image in accordance with the present invention. The machine 710 is not limited to any particular type. Examples of the machine 710 include a personal computer, a digital camera, and a scanner.

The memory 714 may be encoded with additional data for causing the processor 712 to perform other types of pre-processing and post-processing. The additional processing is application-specific.

The data 716 may be provided to the machine 710 via a removable medium 718 such as an optical disc. In the alternative the data 716 may be transmitted to the machine 710.

The processed digital image 720 may be stored in the memory 714 of the machine 710, or it may be stored in memory of another machine. The processed image 720 may also be stored in removable memory 722 such as an optical disc.

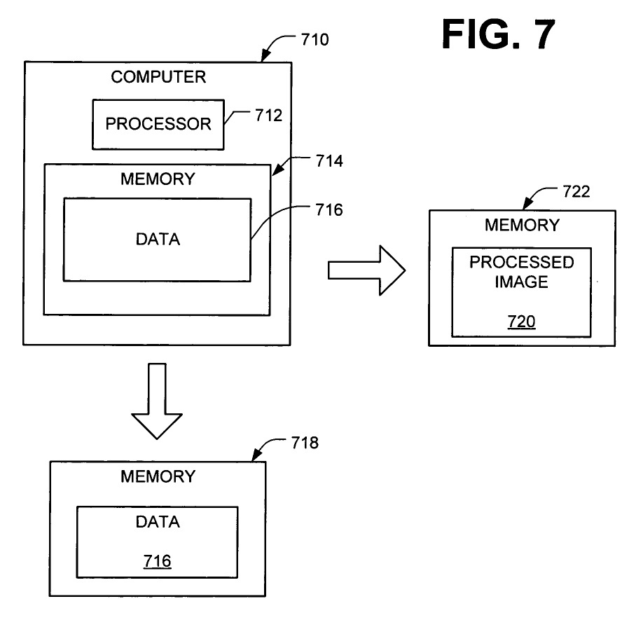

Reference is now made to FIG. 8, which illustrates a digital camera 810 including inexpensive optics 812, a photosensor array 814, and a processor 816. The optics 812 includes a single plastic lens for focusing images on the photosensor array 814. The processor 816 performs functions such as pre-processing (e.g., noise removal, tone mapping), demosaicing, and post-processing. Blur reduction may be performed during the post processing. If noise removal is performed during pre-processing, it does not have to be performed again during blur reduction.

In addition to reducing blur, the method also increases depth-of-field. The camera 810 does not need a focus adjustment, since at least one of the color would be in sharp focus. For example, the optics 812 could be positioned so that the red channel is in fixed focus for distant objects (DO). Consequently, the blue channel will be sharpest for near objects, and the green channel will be sharpest for objects at intermediate distances. Because objects in a scene will have at least one color in focus, objects in all color channels of the image can be sharpened by blur reduction.

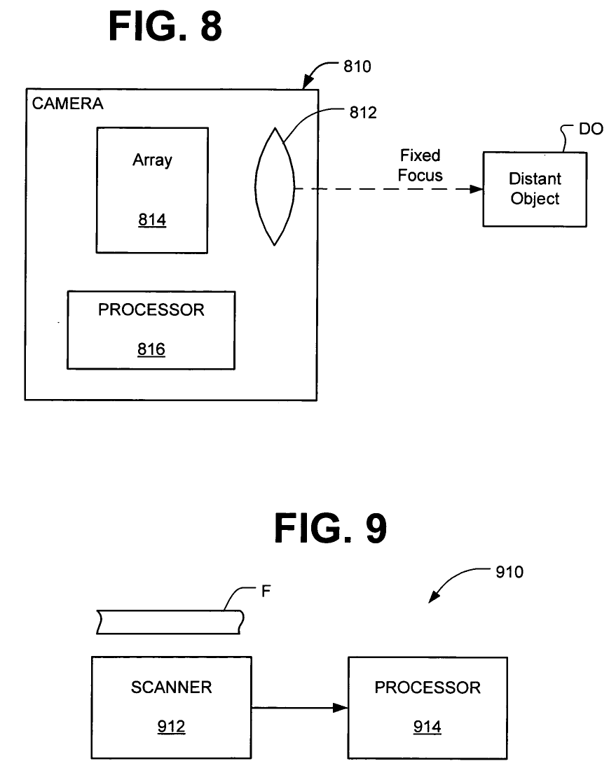

Reference is now made to FIG. 9, which illustrates a system 910 for restoring film (F) that includes a green layer, a blue layer, and a red layer. During restoration, each frame of the film is projected onto a digital sensor. To project the film, light enters the green layer and exits the red layer. Consequently, the green channel is sharpest in the projected image, the blue channel is less sharp, and the red channel is least sharp. Sometimes, blur will appear as red halos around bright objects in the projected images.

The frames of the film (F) are projected onto a color scanner 912. The color scanner 912 provides digital images having registered, full color information at each pixel.

The digital images are sent to a processor 914 for pre-processing, blur reduction, and post-processing. During pre-processing, dust and scratches should be digitally removed from the images. Since the green channel is known to have the least blurring, the processing can be simplified, for example, by creating edge maps for the red and blue channels prior to edge-by edge processing; or skipping the channel identification in the pixel-by-pixel processing and directly computing green-red and green-blue edge differences.

The system 910 may be modified for restoring Technicolor® film. Technicolor® film has three separate reels of film, one for each color. In Technicolor® film, the red film is blurred because it needs to be filmed after the light has passed through the blue film. However, the green and blue channels are equally sharp.

A black and white scanner 912 can be used to scan the film on each reel. The scanned images are supplied to the processor 914.

Before blur reduction is performed, the channels are spatially registered and resampled. For Technicolor® film this can be challenging, since the three film strips may have become warped. This problem can be solved with the same techniques that are used in motion compensation super resolution. In these techniques, consecutive frames of a movie are warped to a reference frame. When applied to Technicolor® film, the sharpest image channel can be used as the reference, and a warping can be found that best fits the other channels to this reference. For example, see a paper by S. Lertrattanapanich and N. K. Bose entitled “HR IMAGE FROM MULTIFRAMES BY DELAUNAY TRIANGULATION: A SYNOPSIS” ICIO IEEE 0-7803-7622-6/02 (2002).

The present invention is not limited to the applications above. Another system could use a combination of infrared radiation and visible (e.g., green) light. The infrared image may be at low resolution, while the green image is at higher resolution. The green light would be considered the sharp color channel, and the infrared image would be considered the blurred color channel. Edge information may be copied from the green image to the infrared image to enhance the low resolution image. Registration would be performed in advance of the blur reduction.

The image channels could have modality other than color. For example, the image channels could be sonar, radar, magnetometer, gravitometer, etc. They could be real or synthetic imagery. They could even be non-image data sets. For example, a plot of population demographics could be sharpened using a map of voting districts.

Although several specific embodiments of the present invention have been described and illustrated, the present invention is not limited to the specific forms or arrangements of parts so described and illustrated. Instead, the present invention is construed according to the following claims.

1. A method of reducing blur in a multi-channel digital image, the method comprising:
comparing first and second color channels of a high frequency feature in the image to derive information that is missing from the second channel due to the blur; and
using the information to adjust the feature in the second channel so that sharpeness of the feature is similar in both the first and second channels.

2. The method of claim 1, wherein the image includes a third color channel, and wherein the method further comprises:
comparing the first and third channels of the high frequency feature to derive additional information that is missing from the third channel due to the blur; and
using the additional information to adjust the feature in the third channel so that sharpeness of the feature is similar in the first, second and third channels.

3. The method of claim 1, wherein a difference is computed between the feature in the first color channel and the feature in the second channel; wherein the difference is high-pass filtered, and wherein the filtered difference is combined with the feature in the second channel.

4. The method of claim 3, wherein the first channel is scaled to have the approximate levels of the second channel prior to computing the difference.

5. The method of claim 3, further comprising using an iterative back-projection to further adjust the sharpness in the second channel.

6. The method of claim 1, wherein comparing the first and second color channels includes computing a blur estimate between the first and second channels; and wherein adjusting the feature in the second channel includes using the first channel to produce a scaled approximation of the second channel; and applying the blur estimate to the scaled approximation to determine a sharpened replacement for the second channel.

7. The method of claim 6, wherein B′=N_{b}(B)+(Bˆ−L_{b}(Bˆ)), where B represents the second channel, Bˆ represents the approximation of the second channel, B′ represents the sharpened replacement for the second channel, L_{b} is a filter representing the blur estimate, and N_{b} is a low pass filter that reduces noise in the second channel.

8. The method of claim 6, further comprising using the sharpened replacement and the first channel to compute a scaled approximation of a third channel, the third channel being blurrier than the second channel; computing a second blur estimate between the first and third channels; and applying the second blur estimate to the scaled approximation of the third channel to determine a sharpened replacement for the third channel.

9. The method of claim 8, wherein B′=N_{b}(B)+(Bˆ−L_{b}(Bˆ)) and C′=N_{c}(C)+(Cˆ−L_{c}(Cˆ)), where B and C represent the second and third channels, Bˆ and Cˆ represent the approximations of the second and third channels, B′ and C′ represent the sharpened replacements for the second and third channels, L_{b} and L_{c} are filters that represent the blur estimates, and N_{b} and N_{c} are low pass filters that reduce noise in the second and third channels.

10. The method of claim 1, further comprising identifying the first channel as being sharper than the second channel.

11. The method of claim 1, further comprising ensuring that the feature has direct spatial correspondence in the first and second channels.

12. The method of claim 1, further comprising removing point-like noise from the image prior to comparing the first and second channels.

13. The method of claim 1, wherein blur reduction is performed globally.

14. The method of claim 1, wherein the blur reduction is performed one pixel at a time.

15. The method of claim 14, wherein the blur reduction of a pixel includes:
high pass filtering a local neighborhood of the pixel;
computing a difference of high pass filtered edges for each channel that is blurred; and
adding the difference values to the corresponding pixel values in the blurred channel.

16. The method of claim 15, further comprising identifying the first channel prior to computing the difference for each channel, whereby the color of the first channel can change from pixel to pixel.

17. The method of claim 15, further comprising using an iterative back-projection to further adjust the sharpness.

18. The method of claim 1, wherein the digital image is captured by an optical system; and wherein the digital image has chromatic aberrations cause by the optical system.

19. The method of claim 1, wherein the digital image is taken from a film having separate color channels.

20. A processor for performing the method of claim 1.

21. An article comprising memory encoded with data for causing a processor to process a digital image according to claim 1.

22. An article comprising memory encoded with the digital image processed according to claim 1.

23. A system comprising a sensor, optics for focusing an image onto the sensor, and a processor for processing an output of the sensor according to the method of claim 1.

24. The system of claim 23, wherein the optics are positioned so that the red channel is in focus for distant objects.

25. A method of restoring film having layers of different colors, the method comprising capturing digital images of the film; and reducing blur in the images as recited in claim 1.

26. The method of claim 25, wherein the film includes multiple strips, each strip corresponding to a color channel; and wherein capturing the film includes scanning frames of each strip and registering the frames.

27. A method for an image capture device, the method comprising capturing an image; pre-processing the image; and reducing blur in the pre-processed image, the blur reduction including:
comparing a sharpest channel to derive high frequency information that is missing from blurred channels due to the blur; and
using the information to adjust the blurred channels so that sharpeness of the blurred channels is similar to the sharpness of the sharpest channel.

28. A method of restoring film, the method comprising projecting frames of the film onto a scanner; and for each frame
computing a blur estimate that, when applied to a first channel, approximates blur in a second channel;
using the first channel to produce a scaled approximation of the second channel; and
applying the blur estimate to the scaled approximation to determine a sharpened replacement for the second channel.

29. The method of claim 28, wherein B′=N_{b}(B)+(Bˆ−L_{b}(Bˆ)), where B represents the second channel, Bˆ represents the approximation of the second channel, B′ represents the sharpened replacement for the second channel, L_{b} is a filter representing the blur estimate, and N_{b} is a low pass filter that reduces noise in the second channel.

30. The method of claim 29, wherein a linear regression is used to compute parameters a and b, where Bˆ=A×a+b≅B.

31. The method of claim 29, further comprising for each frame:
using the sharpened replacement and the first channel to compute a scaled approximation of a third channel, the third channel being blurrier than the second channel;
computing a second blur estimate that, when applied to the first channel, approximates blur in the third channel; and
applying the second blur estimate to the scaled approximation of the third channel to determine a sharpened replacement for the third channel.

32. The method of claim 31, wherein B′=N_{b}(B)+(Bˆ−L_{b}(Bˆ)) and C′=N_{c}(C)+(Cˆ−L_{c}(Cˆ)), where B and C represent the second and third channels, Bˆ and Cˆ represent the approximations of the second and third channels, B′ and C′ represent the sharpened replacements for the second and third channels, L_{b} and L_{c} are filters that represent the blur estimates, and N_{b} and N_{c} are low pass filters that reduce noise in the second and third channels.

33. The method of claim 32, where linear regression is used to compute parameters a, b, c, d and e, where Bˆ=A×a+b≅B and Cˆ=B′×c+A×d+e≅C.

34. The method of claim 28, wherein blur reduction is performed globally.

35. Apparatus comprising a processor for reducing blur in a multi-channel digital image, the blur reduction including
comparing first and second color channels of a high frequency feature in the image to derive information that is missing from the second channel due to the blur; and
using the information to adjust the feature in the second channel so that sharpeness of the feature is similar in both the first and second channels.

36. The apparatus of claim 35, further comprising a sensor, the processor for processing an output of the sensor.

37. The apparatus of claim 36, further comprising optics for focusing images onto the sensor, wherein the optics are positioned so that one of the channels is in focus for objects in the images.

38. The apparatus of claim 36, wherein a scanner includes the sensor, the scanner for scanning film.

39. The apparatus of claim 38, wherein the film includes multiple strips, each strip corresponding to a color channel; and wherein processor registers frames of the strips, uses one of the strips as having the least blur, and reduces blur in the other strips.

40. An article for a processor comprising memory encoded with data for causing the processor to reduce blur in a multi-channel digital image, the blur reduction including:
comparing first and second color channels of a high frequency feature in the image to derive information that is missing from the second channel due to the blur; and
using the information to adjust the feature in the second channel so that sharpeness of the feature is similar in both the first and second channels.
